(19) United States
(12) Patent Application Publication
(10) Pub. No.: US 2008/0301211 A1
(43) Pub. Date: Dec. 4, 2008

(54) SYSTEMS, METHODS AND APPARATUS FOR D-DIMENSIONAL FORMULATION AND IMPLEMENTATION OF RECURSIVE HIERARCHICAL SEGMENTATION

(75) Inventor: JAMES C. TILTON, Bowie, MD (US)

Correspondence Address: NASA GODDARD SPACE FLIGHT CENTER, 8800 GREENBELT ROAD, MAIL CODE 140.1, GREENBELT, MD, 20771, US

(73) Assignees: United States of America as represented by the Administrator of the National Aeronautics and; Space Admin, Washington, DC (US)

(21) Appl. No.: 11/757,024

(22) Filed: Jun. 1, 2007

(51) Int. Cl. G06F 17/10

(52) U.S. Cl. 708/322

(57) ABSTRACT

Systems, methods and apparatus are provided through which in some embodiments of recursive hierarchical segmentation of data with any number of spatial dimensions. Some embodiments of the recursive hierarchical segmentation include computationally efficient parallel implementations and other embodiments of the recursive hierarchical segmentation include computationally efficient serial implementations.

### ORIGIN OF THE INVENTION

This invention was made by an employee of the United States Government and may be manufactured and used by or for the Government for governmental purposes without the payment of any royalties.

### FIELD OF THE INVENTION

This invention relates generally to data analysis and more particularly to recursive data analysis.

### BACKGROUND OF THE INVENTION

Data analysis and compression are increasingly important in information technology, communications, decision-making, manufacturing, and the like. Data grouping (e.g. data clustering or image segmentation) is a key step in a number of approaches to data analysis and compression. In data clustering, data points are grouped together on the basis of the similarity of their feature values. The group of data elements contained in each cluster may provide a good statistical sampling of data values for reliable labeling based on the cluster aggregate feature value, and may also form a basis for data compression. In image analysis, segmentation is the spatial partitioning of image interrelated sections or regions. The group of image data points contained in each region may provide a good statistical sampling of data values for reliable labeling based on data feature values. Further, the region texture, shape, and spatial relationships may be analyzed for additional clues for identifying the nature of the region. In image data compression, the regions form a basis for compact representation of the data. The quality of the prerequisite data grouping is an important factor in determining the level of performance of the data analysis and compression approaches.

There are a variety of data grouping approaches. Each approach has unique characteristics and drawbacks. Some approaches are computationally intensive or not able to be performed in a reasonable amount of time. Other approaches subdivide the data, perform data processing operations, and recombine the subdivided data. These subdividing/recombining approaches are referred to as recursive data processing.

Conventional recursive and data processing approaches are limited in the dimensions of the data that can be processed. For example, in medical image analysis, analyses of two dimensional images of a colon produce numerous false positives in the detection of polyps in virtual colonoscopies, because normal folds in the colon often look like colon polyps in two dimensional views. Two dimensional analyses of other medical images, such as MRI brain scans and mammograms have many of the same problems with ambiguous interpretations.

For the reasons stated above, and for other reasons stated below which will become apparent to those skilled in the art upon reading and understanding the present specification, there is a need in the art for faster and more efficient hierarchical segmentations. There is also a need for increased flexibility in the dimensions of data analyzed.

### BRIEF DESCRIPTION OF THE INVENTION

The above-mentioned shortcomings, disadvantages and problems are addressed herein, which will be understood by reading and studying the following specification.

In one aspect, data is recursively and hierarchically segmented from an arbitrary number of dimensions, with computationally efficient parallel and serial implementations, including an implementation for an arbitrary number of dimensions of an approach for processing window artifact elimination.

In another aspect, a method of analyzing data includes receiving a number of recursion levels for a data set, if the size of each spatial dimension of the data set is evenly divisible by 2̂(number of recursion levels minus one) then padding the data set until the size of all dimensions of the data set are evenly divisible by 2̂(number of recursion levels minus one), thereafter initializing a recursion level to one, segmenting the data set recursively and hierarchically using the recursion level and segmenting the data set hierarchically.

Systems, clients, servers, methods, and computer-readable media of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a flowchart of a method to hierarchically and recursively segment data from an arbitrary number of dimensions, according to an embodiment;

FIG. 2 is a flowchart of a method of recursive hierarchical segmentation, according to an embodiment;

FIG. 3 is a flowchart of a method of processing window artifact elimination, according to an embodiment;

FIG. 4 is a flowchart of a method of creating a list of candidate regions, according to an embodiment;

FIG. 5 is a flowchart of a method of splitting and remerging data, according to an embodiment;

FIG. 6 is a flowchart of a method of recursive restricted hierarchical segmentation, according to an embodiment;

FIG. 7 is a block diagram of a hardware and operating environment in which different embodiments can be practiced; and

FIG. 8 is a particular implementation of a system to hierarchically and recursively segment data in reference to an arbitrary number of dimensions.

### DETAILED DESCRIPTION OF THE INVENTION

In the following detailed description, reference is made to the accompanying drawings that form a part hereof, and in which is shown by way of illustration specific embodiments which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

The detailed description is divided into four sections. In the first section, embodiments of methods are described. In the second section, a hardware and the operating environment in conjunction with which embodiments may be practiced are described. In the third section, particular implementations are described. Finally, in the fourth section, a conclusion of the detailed description is provided.

### Method Embodiments

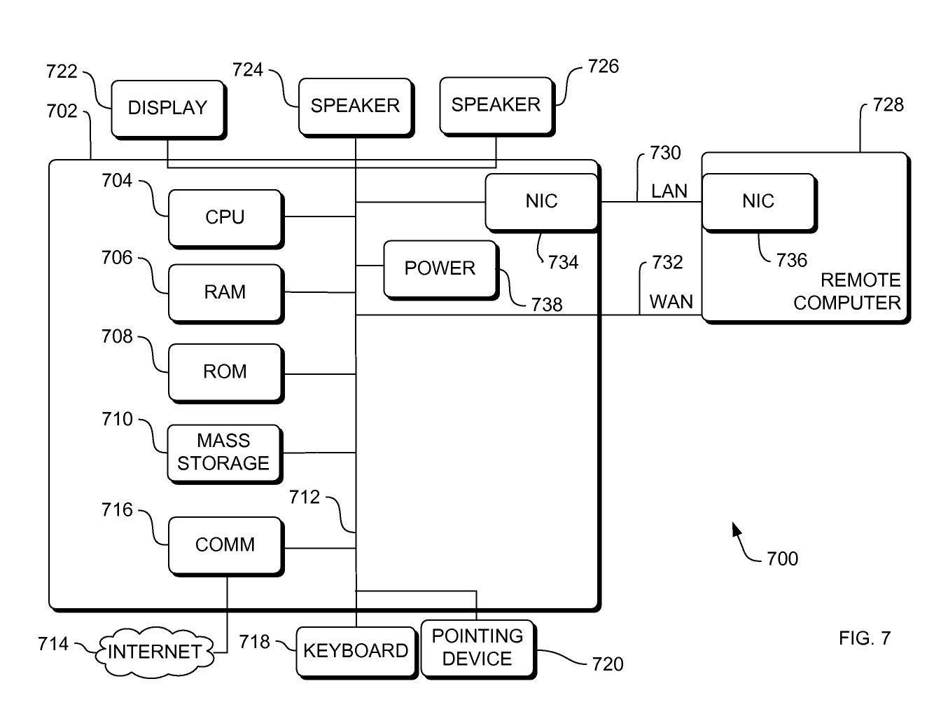

In the previous section, a system level overview of the operation of an embodiment is described. In this section, the particular methods of such an embodiment are described by reference to a series of flowcharts. Describing the methods by reference to a flowchart enables one skilled in the art to develop such programs, firmware, or hardware, including such instructions to carry out the methods on suitable computers, executing the instructions from computer-readable media. Similarly, the methods performed by the server computer programs, firmware, or hardware are also composed of computer-executable instructions. Methods 100-600 are performed by a program executing on, or performed by firmware or hardware that is a part of, a computer, such as computer 702 in FIG. 7.

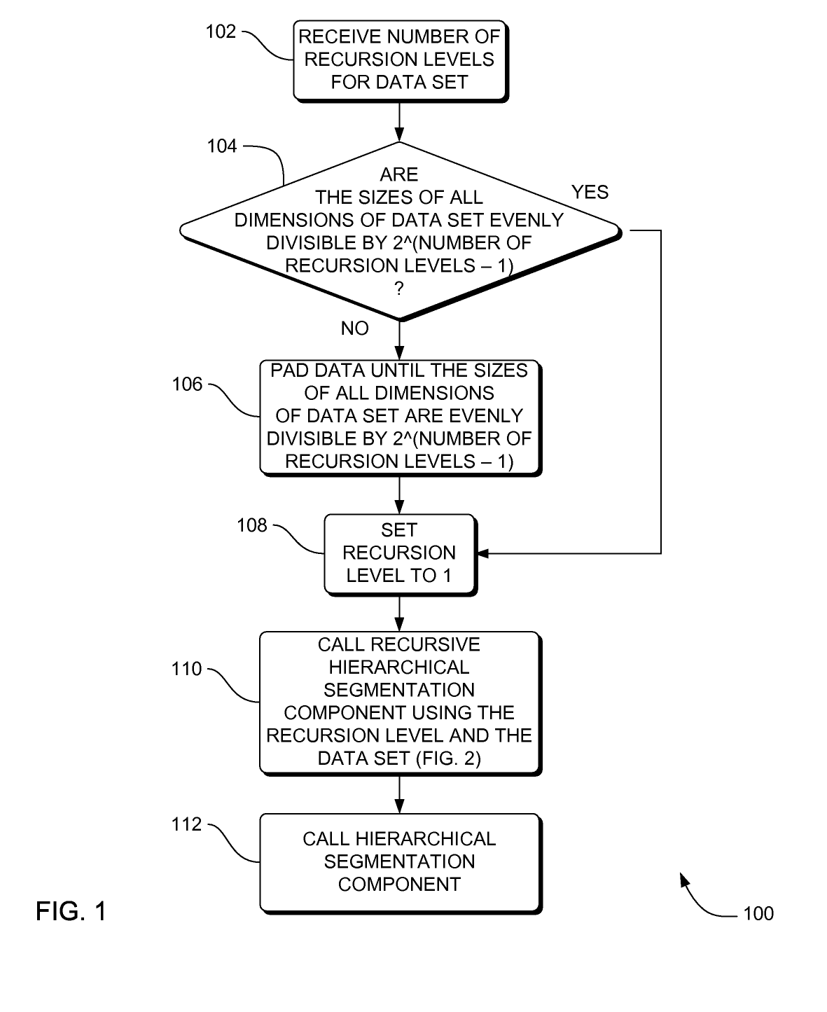

FIG. 1 is a flowchart of a method 100 to hierarchically and recursively segment data from an arbitrary number of dimensions, according to an embodiment. Method 100 solves the need in the art for faster and more efficient hierarchical segmentations and increased flexibility in the dimensions of data analyzed.

Method 100 includes receiving 102 a number of recursion levels for a data set.

Thereafter, method 100 includes a decision as to whether or not the sizes of all dimensions of the data set (e.g. data 102) are evenly divisible by two to an exponent of the number of recursion levels minus one (i.e. 2̂(number of recursion levels−1)) 104. If the result of the decision 104 is false, then the data set is padded 106 until the sizes of all dimensions of the data said are evenly divisible by two to an exponent of the number of recursion levels minus one (i.e. 2̂(number of recursion levels−1)). If the result of the decision 104 is affirmative, or after the padding 106 then the recursion level is set 108 to

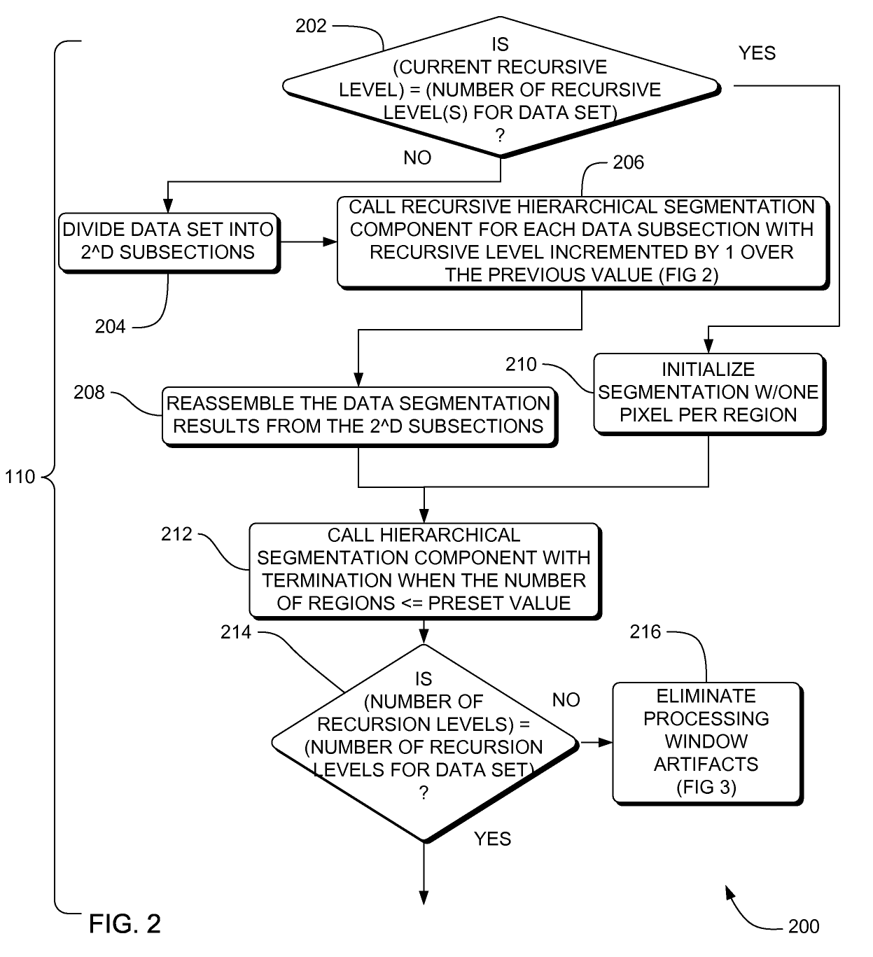

Thereafter, method 100 includes calling 110, a recursive hierarchical segmentation component using the recursion level, and the data set. One example of the process performed by the recursive hierarchical segmentation component is shown in FIG. 2 below.

The parallel implementation of recursive hierarchical segmentation utilizes the parameters inb_levels and onb_levels to designate the recursive levels at which the program pixel-based data are stored upon program initiation (input) and during the final stages of the program (output). If rnb_levels is the maximum number of levels of recursion utilized by recursive hierarchical segmentation, it is required that onb_levels≦inb_levels≦rnb_levels. Thus, the pixel-based data is spread over at least 2̂D(onb_levels−1) processors in the parallel implementation (where D is the number of spatial dimensions in the data), reducing the program RAM memory requirements per individual processor.

The serial implementation of recursive hierarchical segmentation combines the inb_levels and onb_levels into the single parameter ionb_levels (since there is no advantage to having inb_levels greater than onb_levels in the serial implementation) and spreads the pixel-based data over 2̂D(ionb_levels 1) sets of temporary files. This reduces the RAM memory requirements for storing the pixel-based data by a factor of 2̂D(ionb_levels 1). This amounts to a very significant reduction in RAM memory requirements when processing large images.

Upon initialization, the recursive hierarchical segmentation component determines the dimensions of the data processed in each processing window at the recursive level ionb_levels. For an image consisting of M columns and N rows, the processing window at the recursive level ionb_levels has ionb_cols=┐M/2^{(ionb}^{_{—}}^{levels-1)}┐ columns and ionb_rows=┌N/2^{(ionb}^{_{—}}^{levels-1)}┐ rows, where ┌ ┐ is the ceiling operator. For ionb_levels=1, ionb_cols=M and ionb_rows=N, and RHSEG reads the entire input data set into RAM memory and processes the data without the use of temporary files.

For ionb_levels>1, as the input image data (and optionally, the input mask and region label map data) are initially read into recursive hierarchical segmentation, the input data is written out to temporary files for each processing section at recursive level ionb_levels. The sections are numbered in the same manner the parallel processing tasks are numbered. Then, when recursive hierarchical segmentation first reaches the recursive level (level) equal to ionb_levels, the input data for the first processing section is read into random-access memory, and recursive hierarchical segmentation proceeds as previously. When all levels of recursion complete from rnb_levels back up to ionb_levels, the intermediate spatial data (the region label map and other pixel related data) for this section are written to temporary files, and the input data for the next processing section is read into RAM memory, and recursive hierarchical segmentation processes this next processing section as previously. This continues until all processing sections at the recursive level ionb_levels are processed by recursive hierarchical segmentation. Finally, for recursive levels level<ionb_levels, spatial data from the temporary files is read and written as needed by the algorithm.

Using temporary files in the sequential implementation of recursive hierarchical segmentation mimics very closely the data distribution scheme employed by the parallel implementation. The main difference in the spatial data distribution scheme between the two implementations is that in the sequential implementation the spatial data is stored in temporary files for each processing window at ionb_levels, and in the parallel implementation the spatial data is stored in the RAM memory of separate processing nodes for each processing window at recursive processing levels inb_levels through onb_levels (inb_levels>=onb_levels).

Thereafter, method 100 includes calling 112 a hierarchical segmentation component. One embodiment of the process of a hierarchical segmentation component includes calculating the dissimilarity criterion value between all pairs of spatially adjacent regions, finding the pair of spatially adjacent regions with the smallest dissimilarity criterion value (designated as THRESHOLD), and merging that pair of regions. SPCLWGHT is a user supplied parameter that can range from 0.0 through 1.0, that specifies the relative weighting of merging spatially adjacent versus spatially non-adjacent regions. If SPCLWGHT>0.0, after all spatially adjacent regions are merged at a particular dissimilarity criterion value, merges of all spatially non-adjacent regions with dissimilarity←SPCLWGHT*THRESHOLD are performed. If no more merges can be performed, the process is finished. Otherwise, the process of the hierarchical segmentation component continues with the merging of the next most similar pair of spatially adjacent regions.

Method 100 provides a formulation of a recursive approach for hierarchical segmentation of data of an arbitrary number of dimensions, with computationally efficient parallel and serial implementations, including the implementation for an arbitrary number of dimensions of an approach for processing window artifact elimination.

Method 100 decreases processing time requirements due to reduced disk swapping during execution of the program, which in solves the need in the art for faster and more efficient hierarchical segmentations. Method 100 also processes very large images with the sequential implementation of a recursive hierarchical segmentation for which previous versions of recursive hierarchical segmentation would “crash” due to exceeding a computer systems random access memory and swap memory resources

The systems, methods and apparatus described herein are applicable in the analysis of single-band, multispectral or hyperspectral remotely sensed imagery data for earth science applications, image data compression of image data archives, data mining (searching for particular shapes of objects with certain feature vector characteristics), and data fusion (based on matching region features between data sets from different times and/or different sensors). Applications other than remote sensing include the analysis of imagery for medical applications, nondestructive evaluation in manufacturing quality control and land mine detection

FIG. 2 is a flowchart of a method 200 of recursive hierarchical segmentation, according to an embodiment. Method 200 is one example of the process performed by the recursive hierarchical segmentation component invoked in action 110 in FIG. 1 above.

Method 200 includes a decision 202 as to whether or not the current recursive level is equal to the number of recursive levels for the data set (e.g. data 102 in FIG. 1 above). If the result of the decision 202 is false, then the data set is divided 204 into subsections that number 2 to an exponent of the number of dimensions (2̂D). If the result of the decision 202 is false, thereafter a recursive hierarchical segmentation component is called 206 for each data subsection with a recursive level being incremented by one over the previous value of the recursive level. Method 200 in FIG. 2 herein, is one example of the process of the recursive hierarchical segmentation component called in action 206. Action 206 is also one example of the recursive nature of the process. If the result of decision 202 is false, thereafter, and the results of the recursive hierarchical segmentation in action 206 are reassembled 208 from the (2̂D) subsections. If the result of the decision 202 is affirmative, then segmentation is initialized 210 with one pixel per region.

Thereafter, method 200 includes calling 212 a hierarchical segmentation component. One embodiment of the process of a hierarchical segmentation component includes calculating the dissimilarity criterion value between all pairs of spatially adjacent regions, finding the pair of spatially adjacent regions with the smallest dissimilarity criterion value (designated as THRESHOLD), and merging that pair of regions. If SPCLWGHT>0.0, after all spatially adjacent regions are merged at a particular dissimilarity criterion value, merges of all spatially non-adjacent regions with dissimilarity←SPCLWGHT*THRESHOLD are performed. The process is finished when the number of regions is less than or equal to a preset value. Otherwise, the process of the hierarchical segmentation component continues with the merging of the next most similar pair of spatially adjacent regions. One example of the preset value is a range of 1000/2̂D through 4000/2̂D. For example, for a 2-dimensional image, the range would be 250 to 1000.

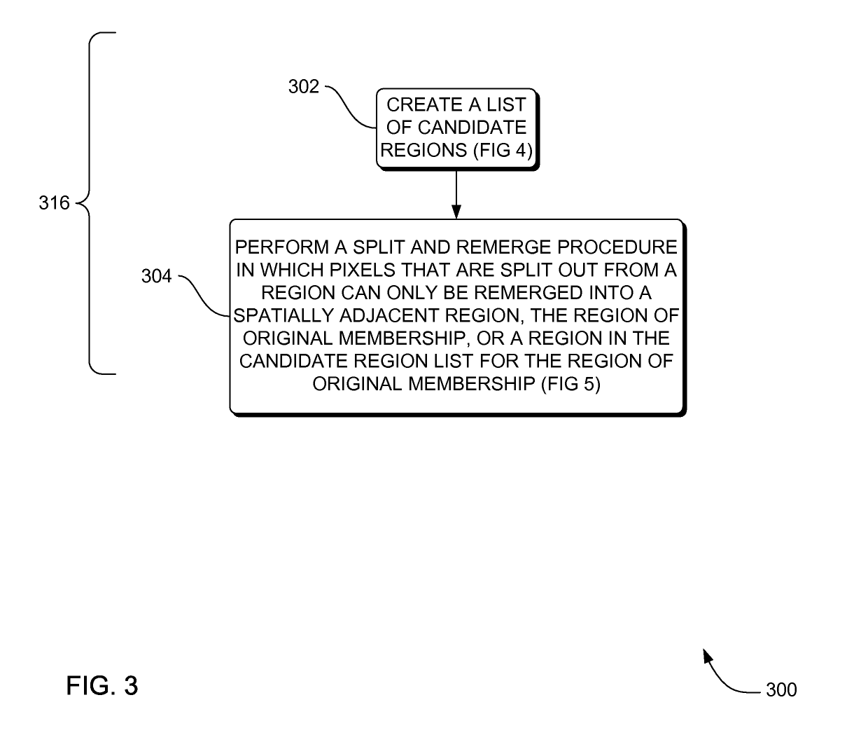

Thereafter method 200 includes a decision 214 as to whether or not the number of recursion levels is equal to the number of recursion levels for the data set. If the result of the decision 214 is false, then processing window artifacts are eliminated 216 in the data set. One example of processing window artifact elimination 216 is shown in method 300 in FIG. 3 below.

FIG. 3 is a flowchart of a method 300 of processing window artifact elimination, according to an embodiment. Method 300 is one example of processing window artifact elimination 216 and the method 200 in FIG. 2 above.

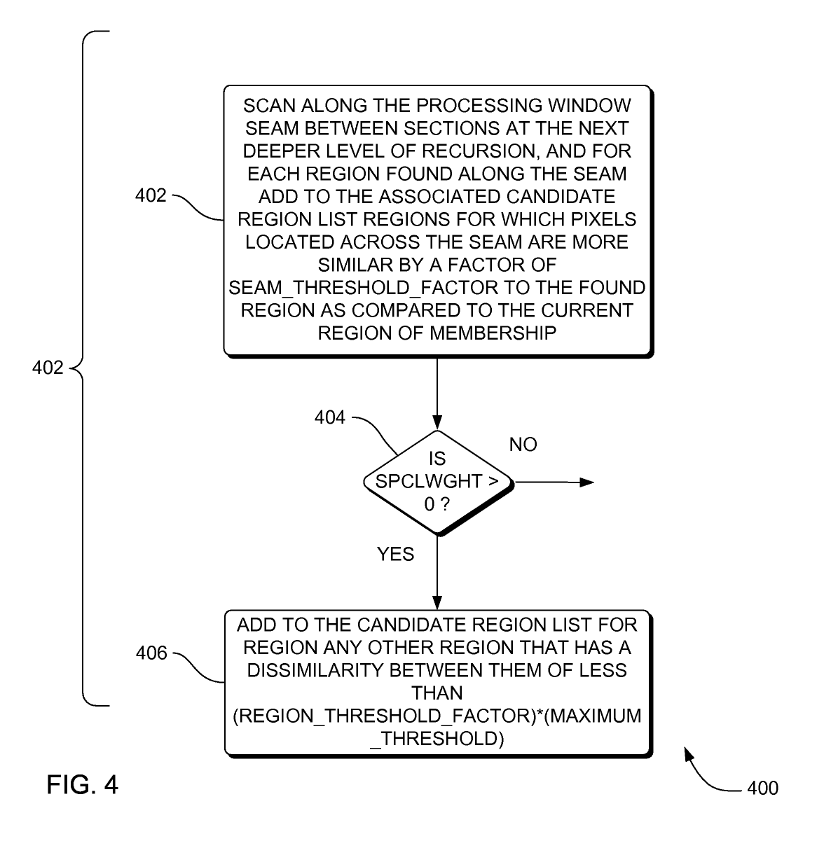

Method 300 includes creating 302 a list of candidate regions. One example of creating 302 a list of candidate regions is shown in method 400 in FIG. 4 below.

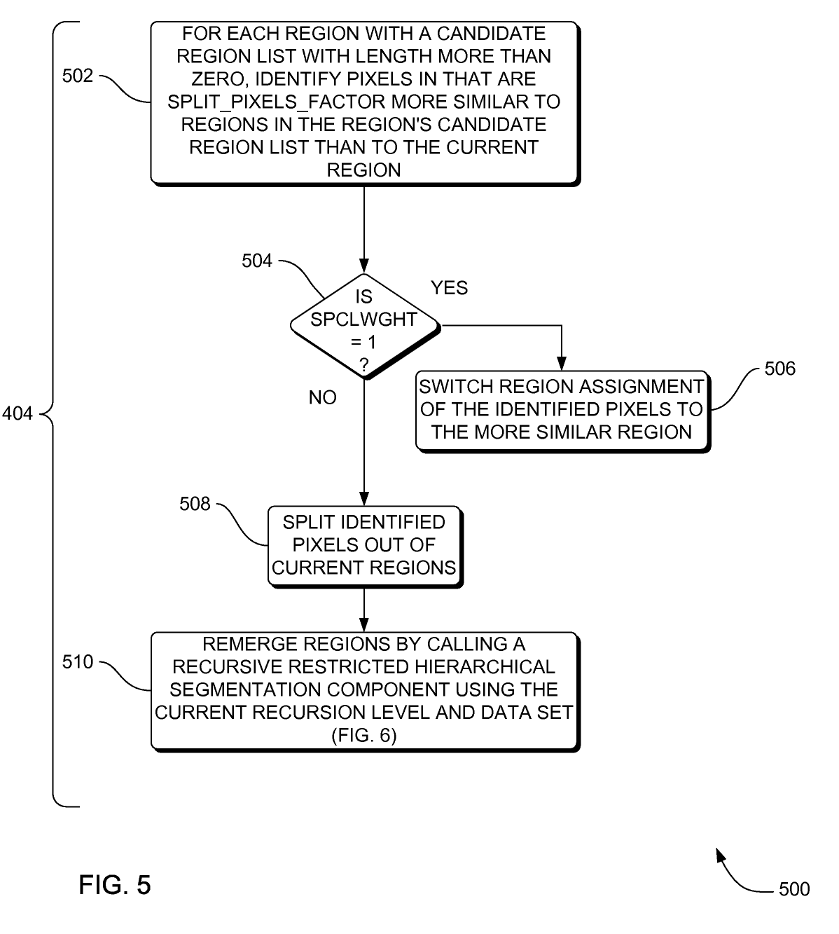

Method 300 thereafter includes splitting and remerging 304 a data set. One example of the data set is the data 102 in FIG. 1 above. In some embodiments the splitting and remerging is performed, such that pixels that are split out from a region can only be remerged into a spatially adjacent region, the region of original membership, or a region in the candidate region list for the region of original membership. One embodiment of the splitting and remerging 304 is shown in method 500 in FIG. 5 below.

FIG. 4 is a flowchart of a method 400 of creating a list of candidate regions, according to an embodiment. Method 400 is one embodiment of creating 302 a list of candidate regions as shown in method 300 in FIG. 3 above.

Method 400 includes scanning 402 along a processing window seam between sections at the next deeper level of recursion and for each region found along the seam, add to the associated candidate region list, regions for which pixels located across the seam are more similar by a factor of seam_threshold_factor to the found region as compared to the current region of membership.

Thereafter, method 400 includes a decision 404 as to whether or not SPCLWGHT>0. If the result of the decision 404 is true, then method 400 also includes adding 406 to the candidate region list for a region, any other region that has a dissimilarity between two regions of less than region_threshold_factor multiplied by maximum value of THRESHOLD (see paragraphs 31 and 37 above) encountered so far.

FIG. 5 is a flowchart of a method 500 of splitting and remerging data, according to an embodiment. Method to 500 is one embodiment of the splitting and remerging 304 as shown in method 300 in FIG. 3 above.

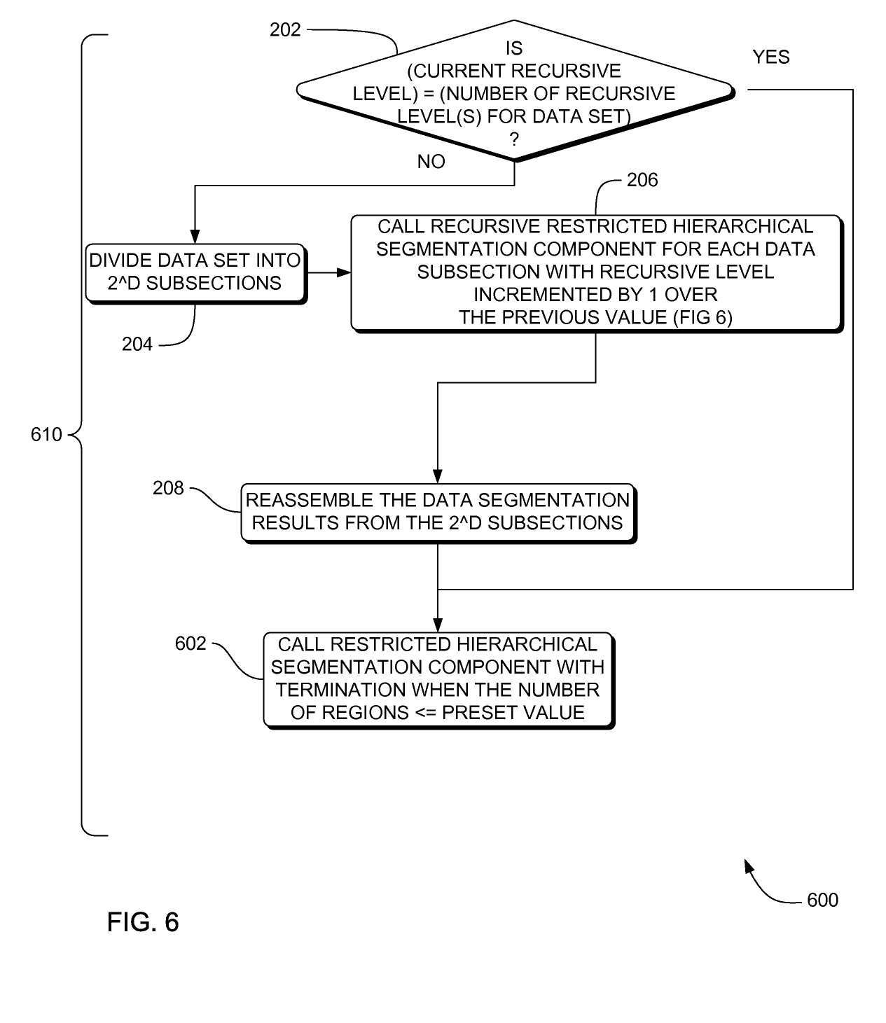

Method 500 includes identifying and 502 for each region with a candidate region lists having a length more than zero, pixels in the candidate region list that are split_pixels_factor more similar to regions in the region candidate region list than to the current list. Method 500 also includes a decision 504 as to whether or not the SPCLWGHT is equal to one. If the result of decision 504 is affirmative, then a region assignment of the identified pixels is switched 506 to the more similar region. If the result of decision 504 is false, then identified pixels are split-out 508 of current regions. Method 500 also includes remerging 510 regions by calling a recursive restricted hierarchical segmentation component using the current recursion level and the data set. One example of the process of the recursive restricted hierarchical segmentation component is shown in method 600 in FIG. 6 below.

FIG. 6 is a flowchart of a method 600 of recursive restricted hierarchical segmentation, according to an embodiment. Method 600 is one embodiment of the process of a recursive restricted hierarchical segmentation component called in action 510 in FIG. 5 above. Method 600 includes calling 602 a restricted hierarchical segmentation component. One embodiment of the process of a restricted hierarchical segmentation component includes calculating the dissimilarity criterion value between the split-out pixels and spatially adjacent regions, the region of original membership, and regions in the candidate region list of the region of original membership, finding the split-out pixel with the smallest dissimilarity criterion value versus a compared region, and merging that pixel into the most similar region. The process of the restricted hierarchical segmentation component is finished when the number of regions (with pixels counted as one pixel sized regions) is less than or equal to a preset value. Otherwise, the process of merging split-out pixels into regions continues. One example of the preset value is a range of 1000/2̂D through 4000/2̂D. For example, for a 2-dimensional image, the range would be 250 to 1000.

In some embodiments, methods 100-600 are implemented as a computer data signal embodied in a carrier wave, that represents a sequence of instructions which, when executed by a processor, such as processor 704 in FIG. 7, cause the processor to perform the respective method. In other embodiments, methods 100-600 are implemented as a computer-accessible medium having executable instructions capable of directing a processor, such as processor 704 in FIG. 7, to perform the respective method. In varying embodiments, the medium is a magnetic medium, an electronic medium, or an optical medium.

### Hardware and Operating Environment

FIG. 7 is a block diagram of a hardware and operating environment 700 in which different embodiments can be practiced. The description of FIG. 7 provides an overview of computer hardware and a suitable computing environment in conjunction with which some embodiments can be implemented. Embodiments are described in terms of a computer executing computer-executable instructions. However, some embodiments can be implemented entirely in computer hardware in which the computer-executable instructions are implemented in read-only memory. Some embodiments can also be implemented in client/server computing environments where remote devices that perform tasks are linked through a communications network. Program modules can be located in both local and remote memory storage devices in a distributed computing environment.

Computer 702 includes a processor 704, commercially available from Intel, Motorola, Cyrix and others. Computer 702 also includes random-access memory (RAM) 706, read-only memory (ROM) 708, and one or more mass storage devices 710, and a system bus 712, that operatively couples various system components to the processing unit 704. The memory 706, 708, and mass storage devices, 710, are types of computer-accessible media. Mass storage devices 710 are more specifically types of nonvolatile computer-accessible media and can include one or more hard disk drives, floppy disk drives, optical disk drives, and tape cartridge drives. The processor 704 executes computer programs stored on the computer-accessible media.

Computer 702 can be communicatively connected to the Internet 714 via a communication device 716. Internet 714 connectivity is well known within the art. In one embodiment, a communication device 716 is a modem that responds to communication drivers to connect to the Internet via what is known in the art as a “dial-up connection.” In another embodiment, a communication device 716 is an Ethernet® or similar hardware network card connected to a local-area network (LAN) that itself is connected to the Internet via what is known in the art as a “direct connection” (e.g., T1 line, etc.).

A user enters commands and information into the computer 702 through input devices such as a keyboard 718 or a pointing device 720. The keyboard 718 permits entry of textual information into computer 702, as known within the art, and embodiments are not limited to any particular type of keyboard. Pointing device 720 permits the control of the screen pointer provided by a graphical user interface (GUI) of operating systems such as versions of Microsoft Windows®. Embodiments are not limited to any particular pointing device 720. Such pointing devices include mice, touch pads, trackballs, remote controls and point sticks. Other input devices (not shown) can include a microphone, joystick, game pad, satellite dish, scanner, or the like.

In some embodiments, computer 702 is operatively coupled to a display device 722. Display device 722 is connected to the system bus 712. Display device 722 permits the display of information, including computer, video and other information, for viewing by a user of the computer. Embodiments are not limited to any particular display device 722. Such display devices include cathode ray tube (CRT) displays (monitors), as well as flat panel displays such as liquid crystal displays (LCD's). In addition to a monitor, computers typically include other peripheral input/output devices such as printers (not shown). Speakers 724 and 726 provide audio output of signals. Speakers 724 and 726 are also connected to the system bus 712.

Computer 702 also includes an operating system (not shown) that is stored on the computer-accessible media RAM 706, ROM 708, and mass storage device 710, and is executed by the processor 704. Examples of operating systems include Microsoft Windows®, Apple MacOS®, Linux®, UNIX®. Examples are not limited to any particular operating system, however, and the construction and use of such operating systems are well known within the art.

Embodiments of computer 702 are not limited to any type of computer 702. In varying embodiments, computer 702 comprises a PC-compatible computer, a MacOS®-compatible computer, a Linux®-compatible computer, or a UNIX®-compatible computer. The construction and operation of such computers are well known within the art.

Computer 702 can be operated using at least one operating system to provide a graphical user interface (GUI) including a user-controllable pointer. Computer 702 can have at least one web browser application program executing within at least one operating system, to permit users of computer 702 to access an intranet, extranet or Internet world-wide-web pages as addressed by Universal Resource Locator (URL) addresses. Examples of browser application programs include Netscape Navigator® and Microsoft Internet Explorer®.

The computer 702 can operate in a networked environment using logical connections to one or more remote computers, such as remote computer 728. These logical connections are achieved by a communication device coupled to, or a part of, the computer 702. Embodiments are not limited to a particular type of communications device. The remote computer 728 can be another computer, a server, a router, a network PC, a client, a peer device or other common network node. The logical connections depicted in FIG. 7 include a local-area network (LAN) 730 and a wide-area network (WAN) 732. Such networking environments are commonplace in offices, enterprise-wide computer networks, intranets, extranets and the Internet.

When used in a LAN-networking environment, the computer 702 and remote computer 728 are connected to the local network 730 through network interfaces or adapters 734, which is one type of communications device 716. Remote computer 728 also includes a network device 736. When used in a conventional WAN-networking environment, the computer 702 and remote computer 728 communicate with a WAN 732 through modems (not shown). The odem, which can be internal or external, is connected to the system bus 712. In a networked environment, program modules depicted relative to the computer 702, or portions thereof, can be stored in the remote computer 728.

Computer 702 also includes power supply 738. Each power supply can be a battery.

### Implementation

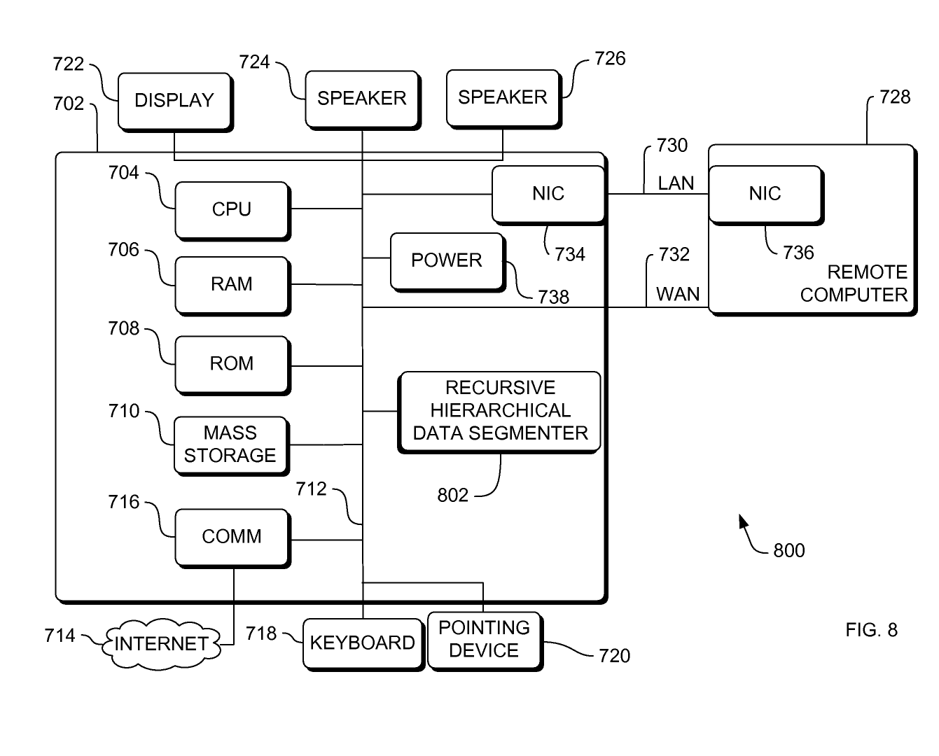

Referring to FIG. 8, a particular implementation is described in conjunction with the system overview in FIG. 1 and the methods described in conjunction with FIGS. 1-7.

Apparatus 800 solves the need in the art for faster and more efficient hierarchical segmentations and increased flexibility in the dimensions of data analyzed.

Apparatus 800 includes a recursive hierarchical data segmenter 802. The recursive hierarchical data segmenter 802 is operable to perform any of the methods described in the FIGS. 1-6 above. Apparatus components of the recursive hierarchical data segmenter 802 can be embodied as computer hardware circuitry or as a computer-readable program, or a combination of both. In another embodiment, system 800 is implemented in an application service provider (ASP) system.

In some embodiments, the recursive hierarchical data segmenter 802 divides the data into 2^{D(rnb}^{_{—}}^{level-1)} sections (where D is the arbitrary number of dimensions) and determines the number of recursive levels, designated as inb_levels (≦rnb_levels), that divides the data into a number of sections less than or equal to the available number of central processing units (P), by solving P≧2^{D(inb}^{_{—}}^{levels-1)}. Then a conventional recursive hierarchical segmentation is performed sequentially for the recursive levels>inb_levels. Having arbitrary number of dimensions as an input variable solves the need in the art for increased flexibility in the dimensions of data analyzed by allowing D to vary from 1 to any number.

More specifically, in the computer-readable program embodiment, the programs can be structured in an object-orientation using an object-oriented language such as Java, Smalltalk or C++, and the programs can be structured in a procedural-orientation using a procedural language such as COBOL or C. The software components communicate in any of a number of means that are well-known to those skilled in the art, such as application program interfaces (API) or interprocess communication techniques such as remote procedure call (RPC), common object request broker architecture (CORBA), Component Object Model (COM), Distributed Component Object Model (DCOM), Distributed System Object Model (DSOM) and Remote Method Invocation (RMI). The components execute on as few as one computer as in computer 702 in FIG. 7, or on at least as many computers as there are components.

### Conclusion

Recursive hierarchical segmentation of data of an arbitrary number of dimensions, including computationally efficient parallel and serial implementations, from an arbitrary number of dimensions, is described. A technical effect of the recursive hierarchical segmentation is processing window artifact elimination. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations. For example, although described in procedural terms, one of ordinary skill in the art will appreciate that implementations can be made in an object-oriented design environment or any other design environment that provides the required relationships.

In particular, one of skill in the art will readily appreciate that the names of the methods and apparatus are not intended to limit embodiments. Furthermore, additional methods and apparatus can be added to the components, functions can be rearranged among the components, and new components to correspond to future enhancements and physical devices used in embodiments can be introduced without departing from the scope of embodiments. One of skill in the art will readily recognize that embodiments are applicable to future communication devices, different file systems, and new data types.

The terminology used in this application is meant to include all object-oriented, database and communication environments and alternate technologies which provide the same functionality as described herein.

We claim:

1. A method to analyze data comprising:
receiving a number of recursion levels for a data set;
padding the data set, if necessary, until the sizes of all dimensions of the data set are evenly divisible by 2̂(number of recursion levels minus one);
initializing a recursion level to one;
segmenting recursively and hierarchically the data set using the recursion level; and
segmenting hierarchically the data set.

2. The method of claim 1, wherein the segmenting recursively and hierarchically the data set further comprises:
initializing segmentation with one pixel per region if the current recursive level is equal to the number of recursive levels for the data set;
dividing the data set into 2̂D subsections if the current recursive level is not equal to the number of recursive levels for the data set;
segmenting recursively and hierarchically each subsections of the data set with the recursive level incremented by one over the previous value if the current recursive level is not equal to the number of recursive levels for the data set;
reassembling data segmentation results from the 2̂D subsections if the current recursive level is not equal to the number of recursive levels for the data set;
segmenting hierarchically with termination, when the number of regions is less than or equal to a preset value; and
eliminating processing window artifacts if the number of recursion levels is not equal to the number of recursion levels for the data set.

3. The method of claim 2, wherein the eliminating window artifacts further comprises:
creating a list of candidate regions; and
performing a split and remerge process in which pixels that are split out from a region can only be remerged into a spatially adjacent region, the region of original membership, or a region in the candidate region list for the region of original membership.

4. The method of claim 3, wherein creating a list of candidate regions further comprises:
scanning along a processing window seam between sections at the next deeper level of recursion, and for each region found along the seam add to the associated candidate region list regions for which pixels located across the seam that are more similar by a factor of a seam_threshold_factor to the found region as compared to the current region of membership; and for the case when SPCLWGHT>0.0,
adding to the candidate region list for a region any other region that has a dissimilarity between the two regions of less than region_threshold_factor multiplied by maximum_threshold.

5. The method of claim 3, wherein performing a split and remerge process further comprises:
identifying pixels that are split_pixels_factor more similar to regions in the region's candidate region list than to the current region for each region with a candidate region a list with a length more than zero;
switching region assignment of the identified pixels to the more similar region if the SPCLWGHT is equal to one;
splitting identified pixels out of current regions if the SPCLWGHT is equal not to one; and
remerging regions if the SPCLWGHT is not equal to one.

6. The method of claim 5, wherein remerging regions further comprises:
segmenting the data set in a restricted, recursive and hierarchical manner.

7. The method of claim 6, wherein segmenting the data set in a restricted, recursive and hierarchical manner further comprises:
segmenting the data set recursively and hierarchically using the current registration level.

8. The method of claim 5, wherein remerging regions further comprises:
dividing the data set into 2̂D subsections if the current recursive level is not equal to the number of recursive levels for the data set;
segmenting recursively and hierarchically each subsection of the data set with the recursive level incremented by one over the previous value if the current recursive level is not equal to the number of recursive levels for the data set;
reassembling data segmentation results from the 2̂D subsections if the current recursive level is not equal to the number of recursive levels for the data set; and
segmenting hierarchically, the data set with termination when the number of regions is less than or equal to a preset value

9. A computer-accessible medium having executable instructions to analyze data, the executable instructions capable of directing a processor to perform:
dividing the data into sections of data, wherein the number of sections of data is 2*D̂(number of required levels of recursion−1) and where D is an arbitrary number of dimensions;
determining the number of recursive levels that divide the data into a number of sections less than or equal to an available number of central processing units; and
segmenting recursively and hierarchically the data for the recursive levels that are greater than a current level of recursion.

10. The computer-accessible medium of claim 1, wherein the number of recursive levels further comprises being less than the number of required levels of recursion

11. The computer-accessible medium of claim 1, wherein the executable instructions capable of directing the processor to perform the determining further comprise executable instructions capable of directing the processor to perform:
solving an available number of central processing units≧2D̂(number of recursive levels−1).

12. A system to analyze data comprising:
a processor;
a storage device coupled to the processor; and
software means operative on the processor to:
recursively and hierarchically segment a data set in reference to an arbitrary number of dimensions.

13. The system of claim 12, wherein the software means operative to recursively and hierarchically segment the data set further comprises:
divide the data into sections of data, wherein the number of sections of data is 2*D̂(number of required levels of recursion−1) and where D is the arbitrary number of dimensions;
determine the number of recursive levels that divide the data into a number of sections less than or equal to an available number of central processing units; and
segment recursively and hierarchically the data for the recursive levels that are greater than a current level of recursion.

14. The system of claim 12, wherein the software means operative to recursively and hierarchically segment a data set further comprises:
receive a number of recursion levels in a data set;
pad the data set, if necessary, until the sizes of all dimensions of the data set are evenly divisible by 2̂(number of recursion levels minus one);
initialize a recursion level to one;
segment recursively and hierarchically the data set using the recursion level; and
segment hierarchically the data set.

15. The system of claim 14, wherein the software means operative to segment recursively and hierarchically the data set further comprises:
initialize segmentation with one pixel per region if the current recursive level is equal to the number of recursive levels for the data set;
divide the data set into 2̂D subsections if the current recursive level is not equal to the number of recursive levels for the data set;
segment recursively and hierarchically each subsection of the data set with the recursive level incremented by one over the previous value if the current recursive level is not equal to the number of recursive levels for the data set;
reassemble data segmentation results from the 2̂D subsections if the current recursive level is not equal to the number of recursive levels for the data set;
segment hierarchically with termination, when the number of regions is less than or equal to a preset value; and
eliminate processing window artifacts if the number of recursion levels is not equal to the number of recursion levels for the data set.

16. The system of claim 15, wherein the software means operative to eliminate processing window artifacts further comprises:
create a list of candidate regions;
perform a split and remerge process in which pixels that are split out from a region can only be remerged into a spatially adjacent region, the region of original membership, or a region in the candidate region list for the region of original membership.

17. The system of claim 16, wherein software means operative to create a list of candidate regions further comprises:
scan along the processing window seam between sections at the next deeper level of recursion, and for each region found along the seam add to the associated candidate region list regions for which pixels located across the seam that are more similar by a factor of a seam_threshold_factor to the found region as compared to the current region of membership; and, for the case when SPCLWGHT>0.0,
add to the candidate region list for a region any other region that has a dissimilarity between the two regions of less than region_threshold_factor multiplied by maximum_threshold.

18. The system of claim 16, wherein software means operative to perform a split and remerge process further comprises:
identify pixels that are split_pixels_factor more similar to regions in the region's candidate region list than to the current region for each region with a candidate region a list with a length more than zero;
switch region assignment of the identified pixels to the more similar region if the SPCLWGHT is equal to one;
split identified pixels out of current regions if the SPCLWGHT is equal not to one; and
remerge regions if the SPCLWGHT is not equal to one.

19. The system of claim 18, wherein the software means operative to remerge regions further comprises:
segment the data set in a restricted, recursive and hierarchical manner.

20. The system of claim 19, wherein segmenting the data set in a restricted, recursive and hierarchical manner further comprises:
segment the data set recursively and hierarchically using the current registration level.

21. The system of claim 18, wherein the software means operative to remerge regions further comprises:
divide the data set into 2̂D subsections if the current recursive level is not equal to the number of recursive levels for the data set;
segment recursively and hierarchically each subsection of the data set with the recursive level incremented by one over the previous value if the current recursive level is not equal to the number of recursive levels for the data set;
reassemble data segmentation results from the 2̂D subsections if the current recursive level is not equal to the number of recursive levels for the data set; and
segment hierarchically, the data set with termination when the number of regions is less than or equal to a preset value

22. A computer-accessible medium having executable instructions to analyze data, the executable instructions capable of directing a processor to perform:
divide the data into sections of data, wherein the number of section of data is 2*D̂(number of required levels of recursion−1) and where D is an arbitrary number of dimensions;
determine the number of recursive levels that divide the data into a number of sections less than or equal to an available number of central processing units; and
segment recursively and hierarchically the data for the recursive levels that are greater than a current level of recursion.
